(19) United States
(12) Patent Application Publication
(10) Pub. No.: US 2012/0118715 A1
(43) Pub. Date: May 17, 2012

(54) BUTTON MODULE

(75) Inventor: Yun-Tang Lin, Taipei City (TW)

(73) Assignee: INVENTEC CORPORATION, Taipei City (TW)

(21) Appl. No.: 12/978,633

(22) Filed: Dec. 27, 2010

(30) Foreign Application Priority Data
Nov. 11, 2010 (TW) 99221876

(51) Int. Cl. H01H 13/50

(52) U.S. Cl. 200/344

(57) ABSTRACT

A button module including a cap, a first arm, a second arm, and a base is provided. The first arm has a first pivoting shaft, a first end connected to the cap, and a second end opposite to the first end. The second arm has a second pivoting shaft, a third end connected to the cap, and a fourth end opposite to the third end and pivoted to the second end. The first pivoting shaft and the second pivoting shaft are pivoted to the base respectively. A projection of the first pivoting shaft on the base is between a projection of the first end on the base and a projection of the second end on the base. A projection of the second pivoting shaft on the base is between a projection of the third end on the base and a projection of the fourth end on the base.

### CROSS-REFERENCE TO RELATED APPLICATION

This application claims the priority benefit of Taiwan application serial no. 99221876, filed on Nov. 11, 2010. The entirety the above-mentioned patent application is hereby incorporated by reference herein and made a part of specification.

### BACKGROUND OF THE INVENTION

1. Field of the Invention

The present invention generally relates to a button module, in particular, to a button module having a cap capable of being lifted up and down in a vertical and non-oblique manner.

2. Description of Related Art

With the rapid development of the technology and the increasing improvement of the people's living quality, computers are widely applied in various information occasions, for example, in traffic information, business communication, work processing, and computer drawing fields. In order to ensure data accuracy and input rapidity, the keyboard is quite important. By pressing the buttons of the keyboard, program instructions or data can be timely, quickly and conveniently input into the computer, to complete the work required to be done.

### SUMMARY OF THE INVENTION

Accordingly, the present invention is directed to a button module having a cap capable of being lifted up and down in a vertical and non-oblique manner.

The present invention provides a button module, which includes a cap, a first arm, a second arm, and a base. The first arm has a first pivoting shaft, and a first end and a second end opposite to each other, in which the first end is connected to the cap. The second arm has a second pivoting shaft, and a third end and a fourth end opposite to each other, in which the third end is connected to the cap, and the fourth end is pivoted to the second end. The first pivoting shaft and the second pivoting shaft are pivoted to the base respectively. An orthogonal projection of the first pivoting shaft on the base is between an orthogonal projection of the first end on the base and an orthogonal projection of the second end on the base. An orthogonal projection of the second pivoting shaft on the base is between an orthogonal projection of the third end on the base and an orthogonal projection of the fourth end on the base.

In an embodiment of the present invention, the first end and the second end are rotated relative to the base along a first direction by using the first pivoting shaft as a pivot point, and the third end and the fourth end are rotated relative to the base along a second direction by using the second pivoting shaft as a pivot point, so as to drive the cap to be close to or away from the base, in which the first direction is opposite to the second direction, and a rotation angle of the first end and the second end relative to the first pivoting shaft is equal to a rotation angle of the third end and the fourth end relative to the second pivoting shaft.

In an embodiment of the present invention, the cap has a first portion and a second portion, in which the first end of the first arm is pivoted to the first portion, the third end of the second arm is pivoted to the second portion, and a moving distance of the first portion relative to the base is equal to a moving distance of the second portion relative to the base.

In an embodiment of the present invention, the button module further includes a balance lever, fixed on the base, in which the cap is buckled on the balance lever.

In an embodiment of the present invention, the base has a pair of third pivoting portions and a pair of fourth pivoting portions, the first pivoting shaft is pivoted between the pair of third pivoting portions, and the second pivoting shaft is pivoted between the pair of fourth pivoting portions.

In an embodiment of the present invention, one of the first arm and the second arm has a pair of fifth pivoting portions opposite to each other, the other one of the first arm and the second arm has a pair of third pivoting shafts arranged back to back, and the pair of fifth pivoting portions are sleeved on the pair of third pivoting shafts.

In an embodiment of the present invention, the button module further includes an elastic member, configured in a projection of the cap on the base, and connected to the base and the cap.

In view of the above, in the embodiments of the present invention, in the button module, through a link rod mechanism formed by the first arm and the second arm, the first end of the first arm and the third end of the second arm have the same moving distance, and thus any part of the cap has the same moving distance relative to the base, so that the cap moves up and down in a vertical manner, to eliminate the problem of being oblique when the button is pressed.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a button module according to an embodiment of the present invention.

FIGS. 2 and 3 are partial cross-sectional views of the button module in FIG. 1.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

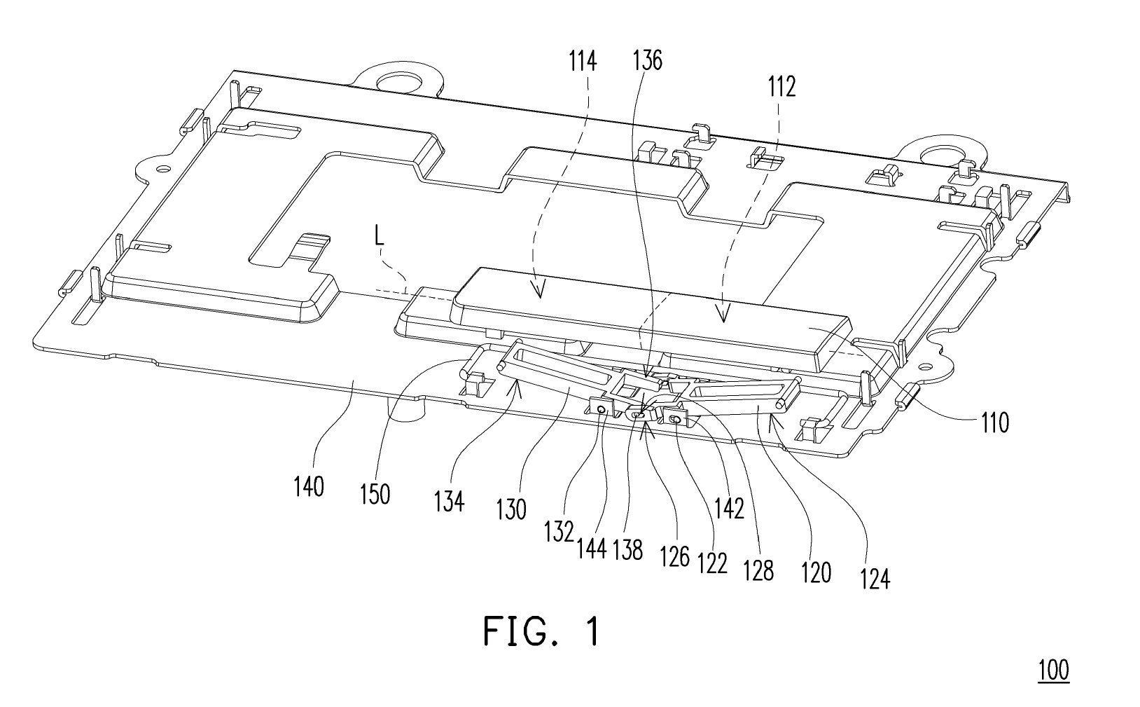

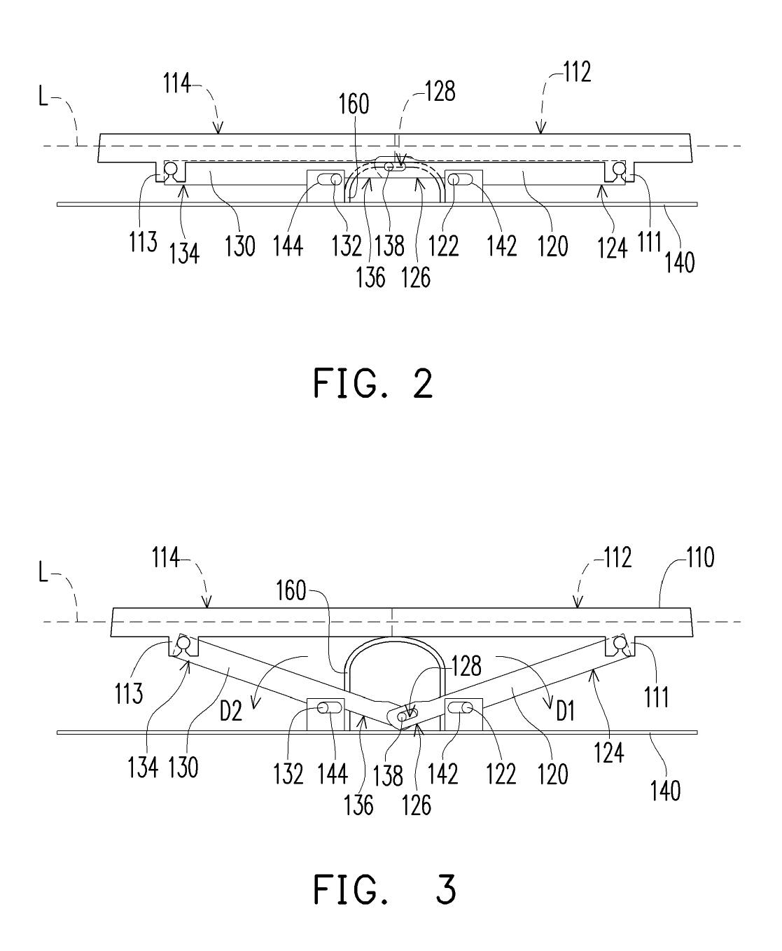

FIG. 1 is a schematic view of a button module according to an embodiment of the present invention, and FIGS. 2 and 3 are partial cross-sectional views of the button module in FIG. 1. Referring to FIGS. 1 to 3, in this embodiment, the button module 100 is applicable to a notebook computer, but this embodiment is not limited thereto. The button module 100 includes a cap 110, a first arm 120, a second arm 130, and a base 140, in which the base 140 is, for example, a casing part of the notebook computer, and is used as a structure supporting the cap 110 and the arms 120 and 130. The first arm 120 has a first pivoting shaft 122, and a first end 124 and a second end 126 opposite to each other. Correspondingly, the second arm 130 has a second pivoting shaft 132, and a third end 134 and a fourth end 136 opposite to each other, in which the first end 124 and the third end 134 are respectively connected to the cap 110, and the second end 126 is pivoted to the fourth end 136.

Further, the first pivoting shaft 122 and the second pivoting shaft 132 are respectively pivoted to the base 140. An orthogonal projection of the first pivoting shaft 122 on the base 140 is between an orthogonal projection of the first end 124 on the base 140 and an orthogonal projection of the second end 126 on the base 140, and an orthogonal projection of the second pivoting shaft 132 on the base 140 is between an orthogonal projection of the third end 134 on the base 140 and an orthogonal projection of the fourth end 136 on the base 140. In other words, the first arm 120 and the second arm 130 substantially form a teeter-totter structure with end portions pivoted to each other, that is, when a part of the cap 110 is pressed to move relative to the base 140, the first arm 120 and the second arm 130 drive the other part of the cap 110 to move towards the base 140, such that the cap 110 moves up and down in a vertical manner relative to the base 140 in parallel, thereby preventing the problem of being oblique when the button module 100 is pressed.

A detailed description is given below. In this embodiment, the cap 110 is in the shape of a rectangular parallelepiped, and has a first portion 112 and a second portion 114 on a major axis L. The cap 110 further has a first pivoting portion 111 and a second pivoting portion 113, respectively corresponding to the first end 124 of the first arm 120 and the third end 134 of the second arm 130. Here, the first pivoting portion 111 and the second pivoting portion 113 are, for example, C-shaped buckling holes, and the first end 124 and the second end 126 have convex-shafts corresponding to the C-shaped buckling holes, such that the first end 124 of the first arm 120 is pivoted to the first portion 112, and the third end 134 of the second arm 130 is pivoted to the second portion 114. However, in this embodiment, the pivoting manner between the arms 120, 130 and the cap 110 is not limited.

In addition, the base 140 has a pair of third pivoting portions 142 and a pair of fourth pivoting portions 144, in which the first pivoting shaft 122 is pivoted between the pair of third pivoting portions 142, and the second pivoting shaft 132 is pivoted between the pair of fourth pivoting portions 144. In this manner, the first arm 120 and the second arm 130 are respectively rotated back and forth in the teeter-totter manner relative to the base 140 by using the first pivoting shaft 122 and the second pivoting shaft 132 as pivot points. Although the pair of third pivoting portions 142 and the pair of fourth pivoting portions 144 are set as an example, here, the disposed number of the third pivoting portions 142 and the fourth pivoting portions 144 is not limited. The pivoting manners capable of enabling the pivoting shafts to be stably pivoted on the base fall within the spirit and the scope of the present invention.

More significantly, the first arm 120 further has a pair of fifth pivoting portions 128 opposite to each other and located on the second end 126, and the second arm 130 further has a pair of third pivoting shafts 138 arranged back to back and located on the fourth end 136. The pair of fifth pivoting portions 128 are sleeved on the third pivoting shafts 138, such that the first arm 120 and the second arm 130 form a link rod mechanism. Therefore, when one of the first arm 120 and the second arm 130 is rotated back and forth relative to the base 140, the other one of the first arm 120 and the second arm 130 is driven to rotate back and forth relative to the base 140.

In this manner, when the first portion 112 of the cap 110 is pressed, the first end 124 of the first arm 120 moves towards the base 140, and thus the second end 126 moves away from the base 140, to drive the fourth end 136 of the second arm 130 to move away from the base 140, such that the third end 134 moves towards the base 140, and the second portion 114 of the cap 110 also moves towards the base 140 to appear in a pressed state. Similarly, when the second portion 114 of the cap 110 is pressed, the first portion 112 of the cap 110, driven by the arms 120 and 130, moves for the same distance. Accordingly, in the button module 100 of the present invention, through the above structure, the cap 110 can move up and down in the vertical manner, thereby preventing the problem of being oblique when the cap 110 is pressed. In other embodiments, the second arm may be provided with a pair of fifth pivoting portions opposite to each other on the fourth end, and the first arm may have pivoting shafts disposed on the second end, so as to form a link rod mechanism through the pivoting of the fifth pivoting portions and the pivoting shafts. Definitely, in the present invention, the disposed number of the fifth pivoting portions and the pivoting shafts is not limited herein. The pivoting manners capable of enabling the fifth pivoting portions and the pivoting shafts to be stably pivoted fall within the spirit and the scope of the present invention.

Further, the first arm 120 and the second arm 130 of the present invention have one end pivoted to each other and are respectively pivoted to the base 140, to form the link rod mechanism capable of moving at the same time, that is, when the first arm 120 is rotated, the first end 124 and the second end 126 have a rotation angle along a first direction D1, and the third end 134 and the fourth end 136 of the second arm 130 are driven to rotate along a second direction D2 opposite to the first direction D1 at the same rotation angle. In other words, through the first arm 120 and the second arm 130 moving at the same time, the moving distance of any part of the cap 110 relative to the base 140 is the same, such that the cap 110 moves up and down in the vertical manner relative to the base 140 in parallel.

It should be noted that the third pivoting portion 142, the fourth pivoting portion 144, and the fifth pivoting portion 128 of this embodiment are, for example, pivoting chutes, such that when the button module 100 is pressed, the pivoting shaft may slide in the pivoting chute, thereby achieving a smooth pressing effect. Definitely, in other embodiments, the pivoting chute may also be designed in other suitable pivoting portions, to achieve the smooth pressing effect of the button module 100, and the present invention is not limited thereto.

In another aspect, the button module 100 further includes a balance lever 150, for example, a Π-shaped rod, in which two ends of the Π-shaped rod are pivoted on the base 140, and a rod portion between the two ends of the Π-shaped rod is, for example, pivoted to a side edge of the cap 110, such that the cap 110 is suitable to be buckled on the balance lever 150. Generally, the cap 110 is a case made of plastics, and the structure thereof is less stable than metal, so that in order to enhance the structural strength of the cap 110 when being pressed, the balance lever 150 is disposed below the cap 110 and the cap 110 is buckled thereon, to achieve desirable structural strength and press feeling of the button module 110.

In addition, in order to enable the cap 110 to automatically return to the position in FIG. 3 after being pressed from the position in FIG. 3 to the position in FIG. 2, an elastic member 160 may be disposed on a projection position of the cap 110 on the base 140, in which the elastic member 160 may be a metal dome or an elastic plastic member, so as to provide a restoring force to enable the cap 110 to automatically return to the initial position.

To sum up, in the embodiments of the present invention, in the button module, through the link rod mechanism formed by the first arm and the second arm, the first end of the first arm and the third end of the second arm have the same moving distance, and thus any part of the cap has the same moving distance relative to the base, so that the cap moves up and down in the vertical manner, to eliminate the problem of being oblique when the button is pressed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A button module, comprising:
a cap;
a first arm, comprising a first pivoting shaft, and a first end and a second end opposite to each other, wherein the first end is connected to the cap;
a second arm, comprising a second pivoting shaft, a third end and a fourth end opposite to each other, wherein the third end is connected to the cap, and the fourth end is pivoted to the second end; and
a base, wherein the first pivoting shaft and the second pivoting shaft are respectively pivoted to the base, a projection of the first pivoting shaft on the base is between a projection of the first end on the base and a projection of the second end on the base, and a projection of the second pivoting shaft on the base is between a projection of the third end on the base and a projection of the fourth end on the base.

2. The button module according to claim 1, wherein when the first end and the second end are rotated relative to the base along a first direction by using the first pivoting shaft as a pivot point, the third end and the fourth end are rotated relative to the base along a second direction by using the second pivoting shaft as a pivot point, the first direction is opposite to the second direction, and a rotation angle of the first end and the second end relative to the first pivoting shaft is equal to a rotation angle of the third end and the fourth end relative to the second pivoting shaft.

3. The button module according to claim 2, wherein the cap comprises a first portion and a second portion, the first end of the first arm is pivoted to the first portion, the third end of the second arm is pivoted to the second portion, and a moving distance of the first portion relative to the base is equal to a moving distance of the second portion relative to the base.

4. The button module according to claim 1, further comprising:
a balance lever, fixed on the base, wherein the cap is buckled on the balance lever.

5. The button module according to claim 1, wherein two ends of the cap are provided with a first pivoting portion and a second pivoting portion respectively, the first end is pivoted to the first pivoting portion, and the third end is pivoted to the second pivoting portion.

6. The button module according to claim 1, wherein the base comprises a pair of third pivoting portions and a pair of fourth pivoting portions, the first pivoting shaft is pivoted between the pair of third pivoting portions, and the second pivoting shaft is pivoted between the pair of fourth pivoting portions.

7. The button module according to claim 1, wherein one of the first arm and the second arm comprises a pair of fifth pivoting portions opposite to each other, the other one of the first arm and the second arm comprises a pair of third pivoting shafts arranged back to back, and the pair of fifth pivoting portions are sleeved on the pair of third pivoting shafts.

8. The button module according to claim 1, wherein the base comprises a plurality of pivoting chutes disposed thereon, and the first pivoting shaft and the second pivoting shaft are respectively pivoted to the pivoting chutes of the base.

9. The button module according to claim 1, wherein one of the second end and the fourth end is disposed with a pivoting chute, the other one of the second end and the fourth end is disposed with a pivoting shaft, and the fourth end and the second end are pivoted to each other through the pivoting chute and the pivoting shaft.

10. The button module according to claim 1, further comprising:
an elastic member, configured in a projection of the cap on the base, and connected to the base and the cap.
